(19) United States
(12) Patent Application Publication
(10) Pub. No.: US 2016/0005110 A1
(43) Pub. Date: Jan. 7, 2016

(54) FINANCIAL SERVICE HUB SYSTEM FOR PROVIDING INTEGRATED FINANCIAL SERVICE

(71) Applicants: CROSSENT INC., Yeongdeungpo-gu, Seoul (KR); KOREA EXPERT INC., Yeongdeungpo-gu, Seoul (KR); UENGINESSOLUTIONS CO., LTD., Gangnam-gu, Seoul (KR); HANA INFORMATION & SYSTEM CO., LTD., Seongnam-si, Gyeonggi-do (KR); MERITZ FINANCIAL INFORMATION SERVICE CO., LTD., Yeongdeungpo-gu, Seoul (KR); MERITZ FIRE & MARINE INSUANCE CO., LTD., Gangnam-gu, Seoul (KR)

(72) Inventors: Hyung Chul CHUN, Gwacheon-si, Gyeonggi-do (KR); Bo Kuk SEO, Yongin-si, Gyeonggi-do (KR); Kyu Ho PARK, Goyang-si, Gyeonggi-do (KR); Jin Young JANG, Seoul (KR); Seo Young PARK, Seoul (KR); Min Sun LEE, Seoul (KR); Jung Kyu JANG, Seoul (KR); Sei Joong KANG, Seoul (KR)

(21) Appl. No.: 14/443,253

(22) PCT Filed: Nov. 30, 2012
(86) PCT No.: PCT/KR2012/010269

§ 371 Date: Sep. 18, 2015

(30) Foreign Application Priority Data
Nov. 16, 2012 (KR) 10-2012-0129944

(51) Int. Cl. G06Q 40/00; G06Q 30/06

(52) U.S. Cl. CPC G06Q 40/00; G06Q 30/06

(57) ABSTRACT

One embodiment of the present invention provides a financial service hub system for providing an integrated financial service, comprising: a common financial service unit for providing a common service specialized for the financial service hub system, and a basic technology service and utility service required for the development of the financial service hub system; and a common product service unit for managing and providing financial information related to a financial product and a financial service, and recommending the financial product and financial service to a client based on client information. Thus, a customized financial product can be provided to the client.

### TECHNICAL FIELD

The following descriptions relate to a financial hub system, and more specifically, to a financial hub system providing integrated financial services.

### BACKGROUND ART

Recently, the financial industry has been gaining momentum high technology devices such as smart televisions, smartphones, tablet personal computers (PCs), etc. Financial enterprises are eager to provide various customized financial products and financial services to customers using such improved smart devices. In other words, financial enterprises do that to provide various personalized financial products combined and derived according to convergence and integration to be suitable for the context of customers in a rapidly changing N-screen environment.

However, current financial enterprises do not effectively provide integrated financial products and services to customers, and product processing systems are operated separately in each domains i.e., banks, insurance, stocks, and credit card industries, and thus interface of a financial system should be changed with each connection between a program and a financial system whenever a new product is introduced in combination or association with another product.

Further, since many systems need to be connected based on information related to various financial products and customer information in resolve it, over usages of cost and time is inevitable.

### DISCLOSURE

### Technical Problem

The present invention is directed to providing a financial service hub system which can provide an integrated financial products and services to a customer.

The present invention is further directed to providing a financial service hub system which can provide a new financial product to a customer without changing an interface of a financial system when developing a new financial product.

### Technical Solution

An aspect of the present invention provides a financial service hub system for providing an integrated financial service, the financial service hub system, including: a common financial service unit configured to provide a common service specialized for the financial service hub system, and a generic technology service and a utility service needed for development of the financial service hub system; and a common product service unit configured to manage and provide financial information related to a financial product and a financial service, and recommend the financial product and the financial service to a customer based on customer information.

Here, the common financial service unit may include a common financial service hub service unit configured to perform organization management on financial organization information and a layer structure, user management on basic personal information of a user, and authority management on authority for each organization or each user.

The common financial service hub service unit may provide an environment configuration function of performing environment configuration parameterization on flexible information according to a feature of an application of the financial service hub system.

Here, the generic technology service and the utility service may include at least one among a cache service providing a cache mechanism, a file compression and decompression service, an E-mail and short message service (SMS) transmission service, an encryption and decryption service, a reading and writing service for an Excel file, an object unit conversion service, and a system file management service.

Here, the common financial service unit may provide at least one of an ID generation service or a message conversion service.

Here, the financial service hub system may further include a common pricing service unit configured to compare a product comparison between financial products, and provide dynamic pricing of calculating a price of a financial product based on customer information.

Here, the financial service hub system may further include a common offering contract service unit configured to process different financial tasks, and collect and transmit contract state information of a customer by being connected to a backbone network.

Here, the financial service hub system may further include an application development support tool unit configured to define development methodology capable of verifying and compensating the financial service hub system, and support pilot development capable of verifying and compensating the financial service hub system based on the development methodology.

Here, the financial service hub system may further include a hub configuration unit configured to define a financial rule applied to the financial service hub system, and configure an environment of the financial service hub system to be able to apply to financial platforms and business environments in which the financial service hub is different.

Here, the financial rule may include at least one among a rule with respect to a workflow providing a task process design tool and an execution engine, a rule with respect to the financial product, a pricing rule, and a rule of the financial service hub system.

### Advantageous Effects

The financial service hub system according to exemplary embodiments of the present invention described above can integrally provide various financial products and financial services in a form that is customized for the customer.

Further, the financial service hub system according to exemplary embodiments of the present invention described above can provide the new financial product to the customer without changing the interface of the financial system when developing a new financial product.

### DESCRIPTION OF DRAWINGS

FIG. 1 is a schematic concept diagram illustrating an integrated financial service environment providing an integrated financial service to a customer using a financial service hub according to an exemplary embodiment of the present invention;

FIG. 2 is a diagram illustrating the financial service hub of FIG. 1 in more detail, and is a diagram in which a configuration of the financial service hub is schematically illustrated;

FIG. 3 is a concept diagram illustrating a hub system according to an exemplary embodiment of the present invention;

FIG. 4 is a concept diagram illustrating a hub system in more detail according to an exemplary embodiment of the present invention;

FIG. 5 is a schematic diagram illustrating a configuration of a common financial service unit according to an exemplary embodiment of the present invention;

FIG. 6 is a schematic concept diagram illustrating a configuration of a common product service unit, a common pricing service unit, and a common offering contract service unit according to an exemplary embodiment of the present invention; and

FIG. 7 is a schematic concept diagram illustrating a configuration of an application development support tool unit according to an exemplary embodiment of the present invention.

### MODES OF THE INVENTION

While the invention is susceptible to various modifications and alternative forms, specific embodiments thereof are shown by way of examples in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms “first,” “second,” “A,” “B,” etc. may be used herein to describe various elements, these elements should not be limited by these terms. These terms are only used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, it will be understood that when an element is referred to as being “directly connected” or “directly coupled” to another element, there are no intervening elements present.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments according to embodiments of the present invention will be described below in more detail with reference to the accompanying drawings.

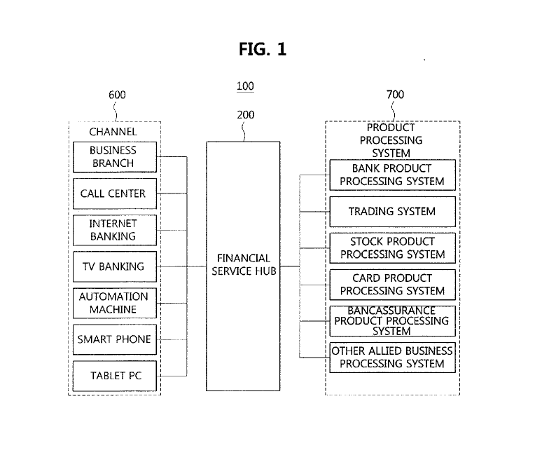

FIG. 1 is a schematic concept diagram illustrating an integrated financial service environment 100 providing an integrated financial service to a customer using a financial service hub 200 according to an exemplary embodiment of the present invention.

As shown in FIG. 1, the integrated financial service environment 100 may include a financial service hub 200 as a center, a channel for directly performing financial work with a customer for providing financial product information to the customer or for making a contract with the customer, etc., and a product processing system 700 having the financial product information.

For example, the channel 600 may include not only a business place for directing meeting the customer such as a business branch, a call center, etc.

But also, the channel 600 may include various devices such as a automation machine, a smartphone, a tablet personal computer (PC), etc., which are capable of performing Internet banking or TV banking.

Further, the channel 600 may support not one operating system but various operating systems such as Windows, iOS, Android, etc.

Moreover, a user of the channel 600 may be a general user who desires to purchase a financial product, or a teller having specialized knowledge and supporting financial consultation, etc., with a customer.

The product processing system 700 may have different product information provision methods and contract methods according to features of various kinds of different financial products, and provide a financial service to the customer through the financial service hub 200.

Particularly, for example, the product processing system 700 may include a bank product processing system for processing a bank task related to various bank products, a trading system for processing a task related to sales of a financial product, etc., a stock product processing system for processing a task related to various stock products, a card product processing system for processing a task related to various cards such as a credit card, a debit card, etc., a bancassurance product processing system for processing a task related to bancassurance, and other allied business processing systems for processing a task related to other allied businesses.

That is, the financial service hub environment 100 according to an exemplary embodiment of the present invention may provide the customer with support for various financial tasks in the product processing system 700 using the channel 600 through the financial service hub 200 in order to provide the integrated financial service.

In other words, the financial service hub 200 may integrate “a development environment, an operating environment, and a management environment of a financial service” capable of rapidly providing a new financial product and a financial service to the customer without connecting many complex financial systems based on information with respect to various financial products and customer information.

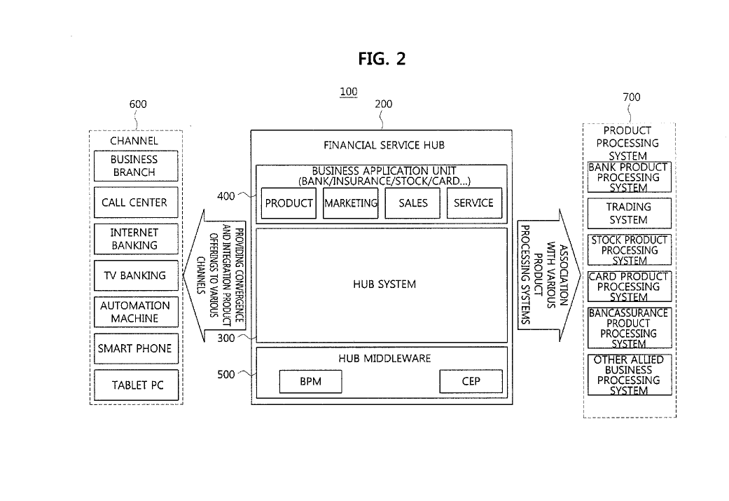

Hereinafter, with reference to FIG. 2, the financial service hub 200 according to an exemplary embodiment of the present invention will be described in more detail. FIG. 2 is a diagram illustrating the financial service hub of FIG. 1 in more detail, and is a diagram in which a configuration of the financial service hub is schematically illustrated.

As shown in FIG. 2, the financial service hub 200 according to an exemplary embodiment of the present invention may include a hub middleware 300 supporting generic technology, a hub enabler 300 supporting various environments so that the financial service hub 200 provides a financial product and a financial service customized for the customer, and a business application unit 400 for applying various practical fields.

Here, for example, the hub middleware 500 may support various generic technologies such as business process management (BPM), complex event processing (CEP), an enterprise service bus (ESB), etc.

Here, the BPM may be methodology standardizing and simplifying a task process and supporting systemization of an atypical task configuration. The CEP may be a data processing method defining an event generation condition to extract a meaningful event among many events generated in real time. The ESB may be a core middle tool grouping the financial services as a logical set to be componentized, and may be an architecture pattern capable of design and development suitable for a business process environment.

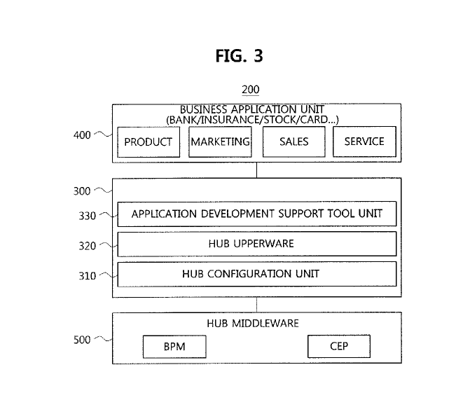

For example, the hub system 300 may provide a function of exchanging or transmitting financial information with/to various financial information systems inside or outside a financial institute in order to make development of the financial service hub 200 convenient. Hereinafter, the hub system 300 will be described in more detail with reference to FIGS. 3 to 7.

The business application unit 400 may manage a variety of financial information which can be applied to a business in which the financial service hub 200 is different, and also apply the financial information by corresponding to a kind of the business. For example, the business application unit 400 may have a variety of information regarding kinds of products, kinds and methods of marketing, kinds and methods of sales, service methods, etc. with respect to various kinds of businesses such as banks, insurance, stocks, cards, etc. Further, the business application unit 400 may apply the information to various financial tasks and financial products, and provide customized financial products and financial services to the customer.

Hereinafter, with reference to FIG. 3, a hub system 300 of the financial service hub (200 of FIG. 1) according to an exemplary embodiment of the present invention will be described in more detail.

FIG. 3 is a schematic concept diagram illustrating a hub system 300 according to an exemplary embodiment of the present invention.

As shown in FIG. 3, the hub system 300 may provide various environments in which various financial products and financial services can be developed and provided using generic technologies such as the BPM and the CEP of the hub middleware 500. The business application unit 400 may provide the financial service and financial product developed through the hub system 300 and applied to various businesses.

The hub system 300 may include a hub configuration unit 310, hub upperware 320, and an application development support tool unit 330.

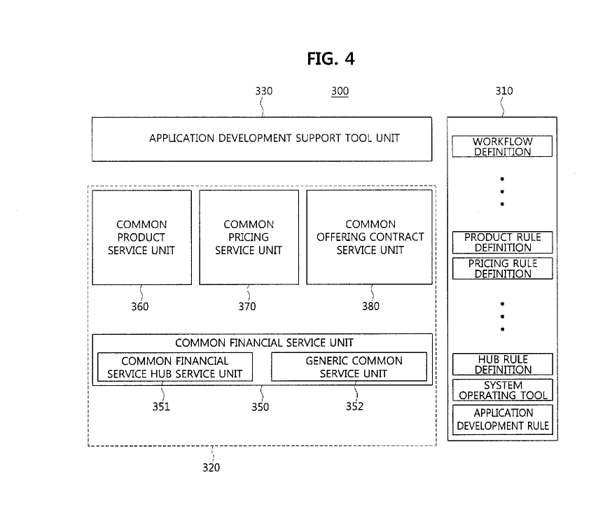

With reference to FIG. 4 together with FIG. 3, the hub system 300 will be described in more detail.

FIG. 4 is a concept diagram illustrating a hub system 300 in more detail according to an exemplary embodiment of the present invention.

First, the hub configuration unit 310 may define a financial rule applied to the financial service hub (200 of FIG. 1), and configure an environment of the financial service hub (200 of FIG. 1) so that the financial service hub (200 of FIG. 1) is applied to various financial platforms and business environments.

Particularly, the financial rule may define a rule of various financial tasks needed for the financial businesses, for example, a workflow, a rule with respect to various financial products, a pricing rule, and a rule of the financial service hub (200 of FIG. 1).

Here, the workflow may provide a task process design tool and an execution engine in association with the financial services such as a task process design, process execution, process monitoring, etc.

Further, the hub configuration unit 310 may include a system operating tool and an application development tool with respect to different systems so that the financial service hub (200 of FIG. 1) is applied to various applications of various of different platforms.

The hub upperware 320 may provide various environments capable of providing an integrated financial product to the customer by providing a standardized product processing process to be suitable for various kinds of different financial services.

For this, the hub upperware 320 may include a common financial service 350, a common product service unit 360, a common pricing service unit 370, and a common offering contract service unit 380.

First, the common financial service unit 350 according to an exemplary embodiment of the present invention will be described.

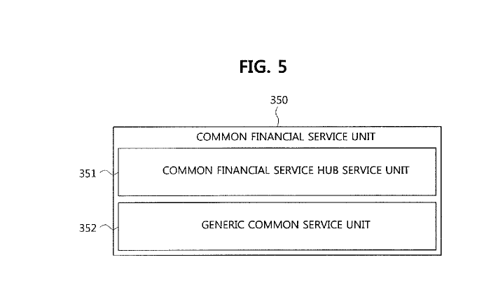

Here, with reference to FIG. 5 together with FIG. 4, the common financial service unit 350 will be described.

FIG. 5 is a schematic diagram illustrating a configuration of a common financial service unit 350 according to an exemplary embodiment of the present invention.

The common financial service unit 350 may provide a common service for the financial service hub (200 of FIG. 1) and a generic common service in which the financial system development is essential.

For this, the common financial service unit 350 may include a common financial service hub service unit 351 and a generic common service unit 352.

The common financial service hub service unit 351 may provide a common service specialized for the financial service hub (200 of FIG. 1).

Particularly, for example, the common financial service hub service unit 351 may manage an organization, a user, and authority, configure an environment, and manage a common code.

For example, the organization management may include management of information of a financial organization such as holding companies, affiliates, associated companies, etc. and a layer structure, the user management may include management of basic personal information of the user, and the authority management may include performing access control on a function that can be used after login of the user according to allocated authority by providing an authority management function for each organization and each user.

Meanwhile, the environment configuration may be a function that can be directly applied when changing only a value in a management user interface (UI) by performing environment configuration parameterization on a variety of flexible information according to a feature of an application of the financial service hub, for example, an application site. The common code management may be management of various kinds of common codes which are suitable for the feature of the application site.

The generic common service unit 352 may provide an essential generic technology service and a utility service needed for the financial system development.

Particularly, for example, the generic common service unit 352 may provide a cache service providing a cache mechanism, a file compression and decompression service, an E-mail and short message service (SMS) transmission service, an encryption and decryption service, reading/writing for Excel files, an object unit conversion service, a system file management service such as generation/change/deletion of a system file, etc.

Further, the generic common service unit 352 may provide various services such as ID generation, a look-up service with respect to various resources in a framework, a message conversion service, etc.

Referring to FIG. 4 again, the common product service unit 360, the common pricing service unit 370, and the common offering contract service unit 380 according to an exemplary embodiment of the present invention will be described.

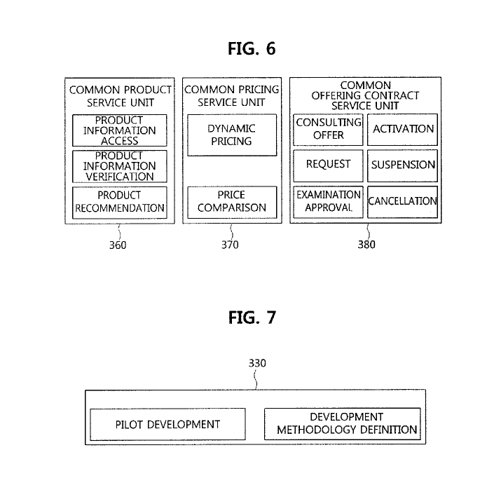

Here, with reference to FIG. 6 together with FIG. 4, the common product service unit 360, the pricing common service unit 370, and the common offering contract service unit 380 will be described.

FIG. 6 is a schematic concept diagram illustrating a configuration of a common product service unit 360, a common pricing service unit 370, and a common offering contract service unit 380 according to an exemplary embodiment of the present invention.

First, the common product service unit 360 may manage and provide the financial product and the financial product information related to the financial service.

Further, the common product service unit 360 may recommend the financial product to the customer based on customer information such as a customer profile, an analysis result of customer tendencies, etc.

Particularly, for example, the common product service unit 360 may manage basic financial product information, and information on a configuration of the financial product, a product rule, etc.

Further, the common product service unit 360 may control whether to access the financial product information, verify the financial product information, and recommend the customized financial product to the customer based on the customer information.

The common pricing service unit 370 may perform a product comparison between the financial products, and calculate prices of the financial products.

Here, dynamic pricing may include dynamically calculating a price of the financial product based on the customer information, and providing a customized financial service.

The common offering contract service unit 380 may provide a service of processing various kinds of financial tasks.

Particularly, for example, the common offering contract service unit 380 may perform a task of processing a consulting offer, an account request, examination approval, etc. and a task of processing customer activity, suspension, cancellation, etc.

Further, the common offering contract service unit 380 may be connected to a backbone network, and collect and transmit contract state information of a specific customer.

Referring to FIG. 4 again, the application development support tool unit 330 according to an exemplary embodiment of the present invention will be described.

Here, with reference to FIG. 7 together with FIG. 4, the application development support tool unit 330 according to an exemplary embodiment of the present invention will be described in more detail.

FIG. 7 is a schematic concept diagram illustrating a configuration of an application development support tool unit 330 according to an exemplary embodiment of the present invention.

The application development support tool unit 330 may define development methodology for verifying and supplementing the financial service hub (200 of FIG. 1), and support pilot development which for verifying and supplementing the financial service hub (200 of FIG. 1) based on the development methodology. Therefore, the application development support tool unit 330 may verify and supplement the financial service hub (200 of FIG. 1).

The application development support tool unit 330 may verify the financial service hub (200 of FIG. 1), and in particular, for example, may verify integration of a financial service hub function through application to an actual task, verify integration of a non-function such as performance, stability, etc., and provide verification data generation and a system environment configuration which are maximally similar to reality.

Further, the application development support tool unit 330 may supplement the financial service hub (200 of FIG. 1), reflect requirements of the customer through the application of the actual task, and provide a development support tool such as an I/O, a service, a DBIO, a tester, etc. through development of the actual task.

Moreover, the application development support tool unit 330 may define application development methodology specialized for a construction of the financial service hub (200 of FIG. 1).

As described above, the financial hub system according to an exemplary embodiment of the present invention may use a standardized financial framework, and provide the integrated financial service to the customer by applying a standardized rule with respect to various financial products and services.

Further, even when the business process and the task rule for each financial institute are different, the financial service hub which can rapidly and easily combine and offer new and various financial products can be constructed by combining the services and configuring the task rule when using the financial service hub system.

The financial service hub system described above can serve to enable the financial service hub.

While the invention has been shown and described with reference to certain exemplary embodiments thereof, it will be understood by those skilled in the art that various changes in form and details may be made therein without departing from the spirit and scope of the invention as defined by the appended claims.

1. A financial service hub system for providing an integrated financial service, the financial service hub system, comprising:
a common financial service unit configured to provide a common service specialized for the financial service hub system, and a generic technology service and a utility service needed for development of the financial service hub system; and
a common product service unit configured to manage and provide financial information related to a financial product and a financial service, and recommend the financial product and the financial service to a customer based on customer information.

2. The financial service hub system of claim 1, wherein the common financial service unit includes a common financial service hub service unit configured to perform organization management on financial organization information and a layer structure, user management on basic personal information of a user, and authority management on authority for each organization or each user.

3. The financial service hub system of claim 2, wherein the common financial service hub service unit provides an environment configuration function of performing environment configuration parameterization on flexible information according to a feature of an application of the financial service hub system

4. The financial service hub system of claim 1, wherein the generic technology service and the utility service include at least one among a cache service providing a cache mechanism, a file compression and decompression service, an E-mail and short message service (SMS) transmission service, an encryption and decryption service, a reading and writing service of an Excel file, an object unit conversion service, and a system file management service.

5. The financial service hub system of claim 1, wherein the common financial service unit provides at least one of an ID generation service or a message conversion service.

6. The financial service hub system of claim 1, further comprising:
a common pricing service unit configured to compare a product comparison between financial products, and provide dynamic pricing of calculating a price of a financial product based on customer information.

7. The financial service hub system of claim 1, further comprising:
a common offering contract service unit configured to process different financial tasks, and collect and transmit contract state information of a customer by being connected to a backbone network.

8. The financial service hub system of claim 1, further comprising:
an application development support tool unit configured to define development methodology capable of verifying and compensating the financial service hub system, and support pilot development capable of verifying and compensating the financial service hub system based on the development methodology.

9. The financial service hub system of claim 1, further comprising:
a hub configuration unit configured to define a financial rule applied to the financial service hub system, and configure an environment of the financial service hub system to be able to apply to financial platforms and business environments in which the financial service hub is different.

10. The financial service hub system of claim 9, wherein the financial rule includes at least one among a rule with respect to a workflow providing a task process design tool and an execution engine, a rule with respect to the financial product, a pricing rule, and a rule of the financial service hub system.
